(19) United States
(12) Patent Application Publication
(10) Pub. No.: US 2011/0225139 A1
(43) Pub. Date: Sep. 15, 2011

(54) USER ROLE BASED CUSTOMIZABLE SEMANTIC SEARCH

(75) Inventors: Luming Wang, Bellevue, WA (US); Xiaohong Yang, Sammamish, WA (US); Anton Amirov, Redmond, WA (US); Malik Hussain, Woodinville, WA (US)

(73) Assignee: Microsoft Corporation, Redmond, WA (US)

(21) Appl. No.: 12/721,704

(22) Filed: Mar. 11, 2010

(51) Int. Cl. G06F 17/30

(52) U.S. Cl. 707/709; 707/711; 707/728; 707/E17.008; 707/E17.108; 726/7; 707/E17.032

(57) ABSTRACT

User role based customizable searches, where crawled documents may be evaluated against user roles or attributes during crawl time, are provided. Metadata retrieved from searched documents may also be evaluated against the user roles and/or attributes such that customized search results ranking documents based on their content beyond textual content may be provided.

### BACKGROUND

Search engines discover and store information about documents such as web pages, which they typically retrieve from the textual content of the documents. The documents are sometimes retrieved by a crawler or an automated browser, which may follow links in a document or on a website. Conventional crawlers typically analyze documents as flat text files examining words and their positions (e.g. titles, headings, or special fields). Data about analyzed documents may be stored in an index database for use in later queries. A query may include a single word or a combination of words.

Usefulness of a search engine depends on the relevance of the result set it returns. While there may be a large number of documents that include a particular word or phrase, some pages may be more relevant, popular, or authoritative than others. Thus, many search engines employ a variety of methods to rank the results. Some search engines utilize predefined and/or hierarchically ordered keywords that have been pre-programmed. Other search engines generate the index by analyzing located texts automatically.

Some aspects of search that is typically not taken into account by conventional search engines is that same words may have different meanings to different users. Moreover, the same document may be more important to a group of people and less important to another group of people based on the contained information. Furthermore, different contents of a document such as images, graphics, or text may influence an importance of the document to different users. Thus, flat text based searches fail to consider a significant portion of information regarding available documents when ranking documents.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed to user role based customizable searches, where crawled documents may be evaluated against user roles or attributes. According to some embodiments, metadata retrieved from searched documents may also be evaluated against the user roles and/or attributes such that customized search results ranking documents based on their content beyond textual content may be provided.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF THE DRAWINGS

FIG. 1 is a diagram illustrating use of different user roles in performing searches across various sources;

FIG. 2 is a conceptual diagram illustrating user role based search operations in a desktop search environment;

FIG. 3 is a conceptual diagram illustrating user role based search operations in a networked search environment;

FIG. 4 illustrates examples of how a user role based search may focus on different contents of a document in a system according to embodiments;

FIG. 5 is a networked environment, where a system according to embodiments may be implemented;

FIG. 6 is a block diagram of an example computing operating environment, where embodiments may be implemented; and

FIG. 7 illustrates a logic flow diagram for a process of performing user role based customizable search according to embodiments.

### DETAILED DESCRIPTION

As briefly described above, user roles such as organizational hierarchy, membership in an organization, attributes, etc., may be determined and used in performing customizable searches evaluating crawled documents against user roles or attributes. Moreover, metadata retrieved from searched documents may also be evaluated against the user roles and/or attributes such that customized search results may be ranked accordingly. Thus, a search engine/application according to embodiments performs a semantic search deriving meaning from searched content, metadata, user role(s), predefined rules, etc. In the following detailed description, references are made to the accompanying drawings that form a part hereof, and in which are shown by way of illustrations specific embodiments or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

While the embodiments will be described in the general context of program modules that execute in conjunction with an application program that runs on an operating system on a personal computer, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium can for example be implemented via one or more of a volatile computer memory, a non-volatile memory, a hard drive, a flash drive, a floppy disk, or a compact disk, and comparable media.

Throughout this specification, the term “platform” may be a combination of software and hardware components for managing computer and network operations, which may include searches. Examples of platforms include, but are not limited to, a hosted service executed over a plurality of servers, an application executed on a single server, and comparable systems. The term “server” generally refers to a computing device executing one or more software programs typically in a networked environment. However, a server may also be implemented as a virtual server (software programs) executed on one or more computing devices viewed as a server on the network. More detail on these technologies and example operations is provided below.

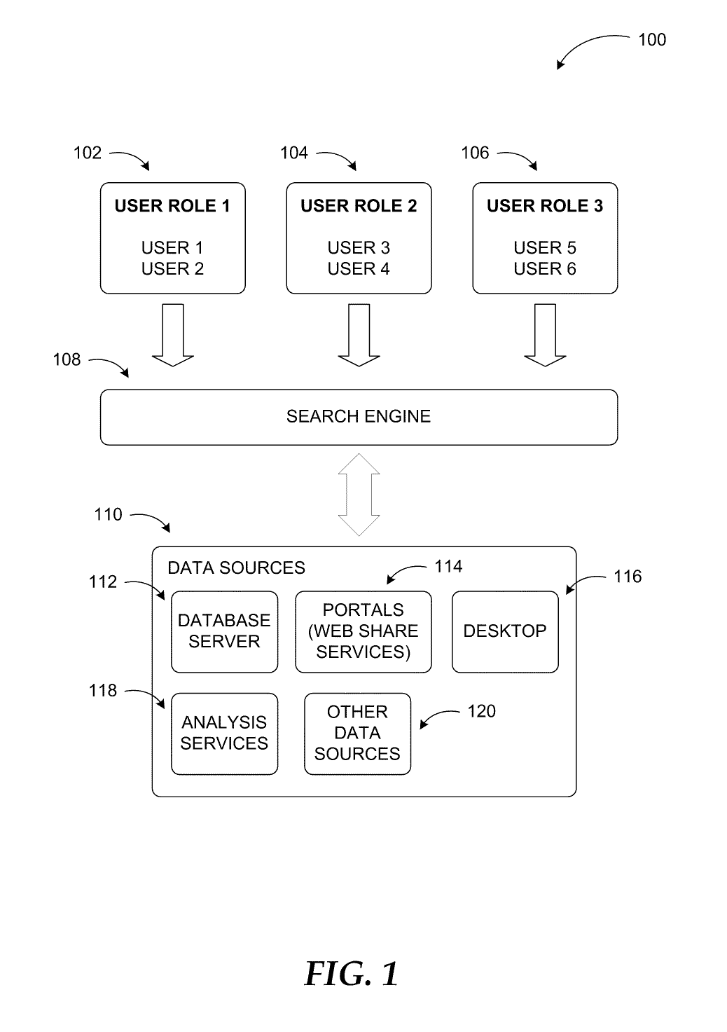

FIG. 1 is a diagram illustrating use of different user roles in performing searches across various sources. One measure for the quality of a search engine is the relevance of the result set it returns. As mentioned previously, search engines employ a variety of methods to rank the results or index them based on relevance, popularity, or authoritativeness of documents compared to others. Indexing also allows users to find sought information promptly.

When a user submits a query to a search engine (e.g. by using key words), the search engine may examine its index and provide a listing of matching results according to predefined criteria. The index may be built from the information stored with the crawled document and/or user data and the method by which the information is indexed. The query may include parameters such as Boolean operators (e.g. AND, OR, NOT, etc.) that allow the user to refine and extend the terms of the search.

A search engine according to embodiments enables enhanced indexing of search results by taking user roles/attributes into account. As shown in diagram 100, different users may have varying roles or attributes within an organization such as user roles 102, 104, and 106. For example, a document may include data portions of which are of interest to different people. A teacher may be interested in grades of his/her class for a particular year, while a principal is interested in overall grade point averages and a counselor is interested in progress reports. Thus, the same grade report document for a school may carry different weights for different people. Following the same example, grades may be stored in different documents all named grade reports. Reporting the individual grades document to the principal may unnecessarily clutter the principal's search results and vice versa. Moreover, even if all the data are stored in one document, a search engine according to embodiments may render different descriptions of the document to different users based on their interests (rules).

Thus, search engine 108 according to some embodiments may take the roles of the users into account and rank the documents accordingly employing customizable rules defined to evaluate the importance of a document for a specific user role as described in more detail below. The user roles may be based on organizational hierarchies within an enterprise and/or attributes of users based on their profession, age, social status, membership or hierarchy in an organization (e.g. a social network), gender, etc. Roles are not limited to these example ones and may include any attribute such as a hobby, a subscription to a particular publication, and similar ones.

The users' attributes may define different meanings for words being used as search term. For example, a doctor may mean something different when they search for test compared to a student. Similarly, credentials of a user such as their permission levels may be used by search engine as well. A manager within an organization may have different permission levels compared to a sales representative. Thus, documents with content not accessible to the sale representative may be de-prioritizes in a search, while documents with restricted access may be determined to be more relevant for the manager.

Customizable business rules may also define different groups of metadata. For example, data source, data type, content distribution, and similar attributes associated with searched documents may be used to further enhance ranking of search results. Moreover, rules may define importance of a metadata group for specific user roles. For example, documents may be tagged as sales summary report or as forecast reports. These document metadata may help prioritize the document(s) differently for sales managers or marketing managers in addition to the documents' contents.

In addition to employing customizable evaluation rules based on user roles and metadata, customizable rendering rules may also be utilized to render the search results based on the importance of the content and metadata of the documents. Thus, search engine 108 may perform the search(es) utilizing the customizable rules passing them as query parameters at crawl time on data sources 110, which may include database server 112, analysis services 118, portals 114 (e.g. web share services), desktop 116, and other data sources 120.

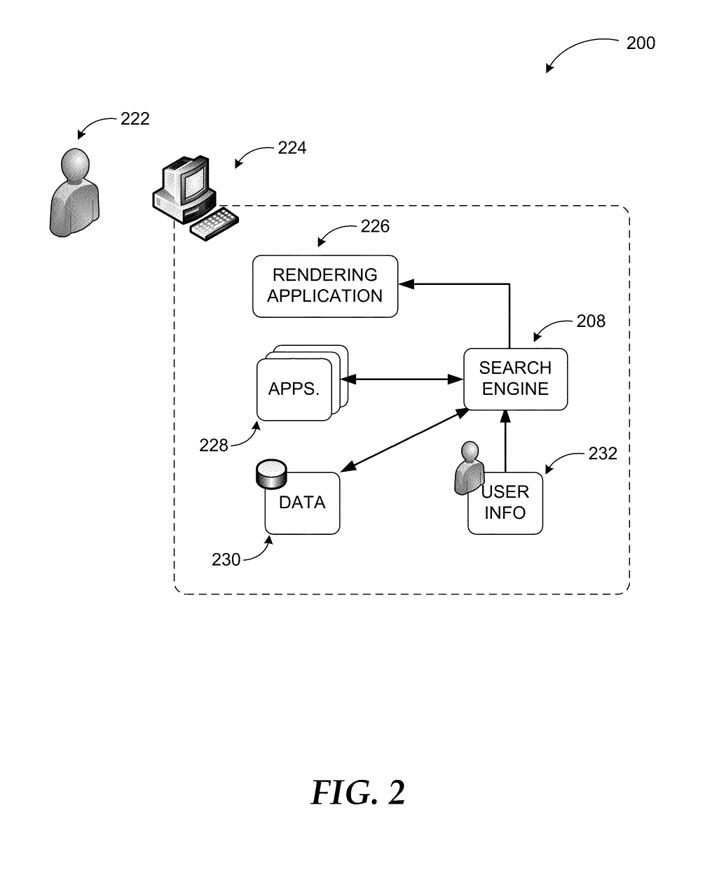

FIG. 2 is a conceptual diagram illustrating user role based search operations in a desktop search environment. Search operations may be performed in different environments. One example environment, user's desktop is shown in diagram 200.

User 222 may execute a number of applications 228 in their computing device 224. Some of the applications may be executed locally, while other may be distributed applications executed on other computing devices and accessed through computing device 224. Data 230 may be any data generated and/or consumed by applications 228 or other wide stored in computing device 224.

Search engine 208 may receive user information 232 such as user roles, attributes, permissions, and similar credentials and determine customizable rules for evaluating documents. The roles may be determined through lookup (e.g. looking up a table of user credentials and corresponding roles, etc.), inference (e.g. an automatic inference algorithm inferring a user role based on the user's email address, etc.), predefined rules defining user roles, or similar methods. User credentials or identities may be received by the search engine 208 through a user interface input (e.g. log in) or through the operating system and/or another application. The rules, as mentioned above, may be predefined (e.g. by an administrator) or dynamically determined based on user roles and search terms by a search application. For example, a search for “music” may not take into account a user's organizational position, but his/her age, membership in a social network, language preferences, and similar attributes. Search results indexed based on evaluating document contents and metadata may be provided to rendering application 226, which may use additional customizable rules based on user roles to rank rendering of documents and associated metadata before rendering the search results to user 222.

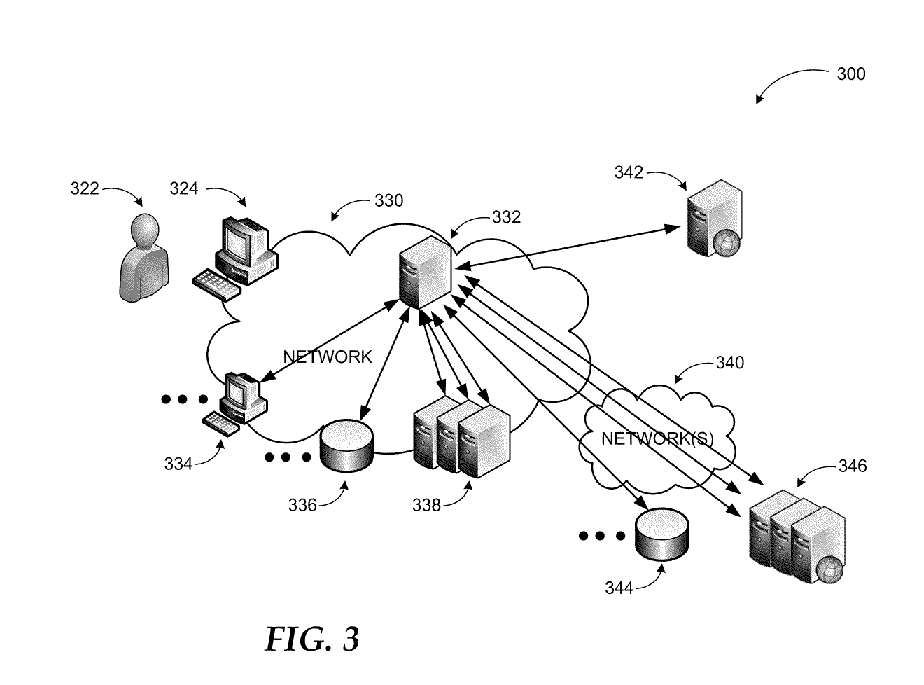

FIG. 3 is a conceptual diagram illustrating user role based search operations in a networked search environment. The networked search environment shown in diagram 300 is for illustration purposes. Embodiments may be implemented in various networked environments such as enterprise-based networks, cloud-based networks, and combinations of those.

User 322 may interact with a variety of networked services through their client 324. Client 324 may refer to a computing device executing one or more applications, an application executed on one or more computing devices, or a service executed in a distributed manner and accessed by user 322 through a computing device. In a typical system client 324 may communicate with one or more servers (e.g., server 332). Server 332 may execute search operations for user 322 searching documents on server 332 itself, other clients 334, data stores 336, other servers of network 338, or resources outside network 330.

In an example scenario, network 330 may represent an enterprise network, where user 322 may provide their credentials to login (e.g. a user name, a password, an email address, and the like). Based on the provided credentials, the search application on server 332 may determine customizable rules based on user roles (e.g. enterprise roles) and evaluate documents and associated metadata. The search may also include resources outside network 330 such as server 342 or servers 346 and data stores 344, which may be accessed through at least one other network 340.

As discussed above, user 322 may provide a credential (e.g. a login, username/password, a certificate, a personal identification number, and comparable ones) for accessing network 330 that includes server 332 executing the search application. User 322 may have multiple identities associated with different services. These sub-identities may be determined from the provided credential through a look-up operation, by inferring from user credentials (e.g. user email address), or by executing an algorithm that, for example, may derive a number of user identities from an encrypted user credential through decryption. Once the sub-identities are determined, user's (322) roles may be determined based on enterprise rules, associations, personal information, and comparable data.

According to other embodiments, user 322 may provide at least some of the sub-identities directly through a credential input user interface (e.g. entry of user name). The determination of the user roles may be performed on-demand (user indication), randomly, or periodically. Determined user roles may be cached or persistently stored for subsequent use. The determination schedule, whether or not the determined roles are to be cached, and associated determination mechanisms may be established based on the individual sub-identities.

The user role provision and determination methods discussed above are example methods provided for illustrative purposes and do not constitute a limitation on embodiments. User role(s) for enhancing search operations may be determined in a variety of ways such as look-up operations, automated inference, and the like, using the principles described herein.

Thus, in a system according to embodiments, documents may be evaluated determining the importance of each document based on various user role based rules. Metadata from the documents may also be grouped and each metadata group evaluated based on the user roles. Documents whose content and/or metadata are deemed to be more important for a particular user may be ranked higher. Each group of metadata may also be customized for each user role for rendering purposes.

The example systems in FIGS. 1, 2, and 3 have been described with specific servers, client devices, software modules, and interactions. Embodiments are not limited to systems according to these example configurations. A user role based customizable search system may be implemented in configurations employing fewer or additional components and performing other tasks. Furthermore, specific protocols and/or interfaces may be implemented in a similar manner using the principles described herein.

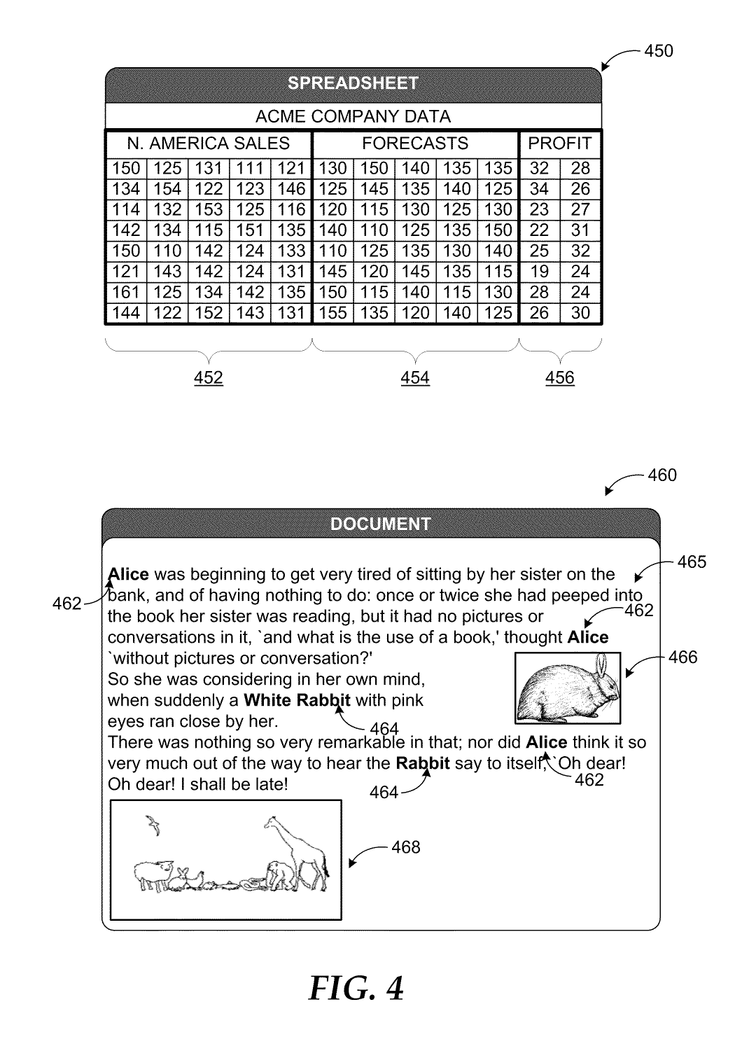

FIG. 4 illustrates examples of how a user role based search may focus on different contents of a document in a system according to embodiments. While embodiments may be implemented on any document type, two example documents are illustrated in FIG. 4.

Document 450 is an example spreadsheet document. Document 450 includes sales related information for a company. Portions of the data in the document 450 may be relevant to different people, or even restricted for display depending on different users' permission levels. For example, North America Sales data 452 may be relevant to a sales representative, while Forecasts 454 may be relevant to a marketing person. Similarly, profit reports 456 may be relevant to an executive. Thus, a search according to some embodiments may retrieve the entire document or portions of it depending on the user's role or attribute.

Document 460 may be a word processing document with textual and graphical elements. According to an example scenario, a child searching for animal stories may be more interested in the graphics 466 and 468 of document 460. An adult searching for stories may find the textual part 465 more relevant. Similarly, a teenager may be more interested in characters in a story and the character names 462 and 464 may be relevant for that particular user. In addition to the illustrated content types, which may be evaluated against user roles and attributes by a search engine according to embodiments, metadata associated with the document 460 such as tags assigned to the document indicating document type, assigned keywords, etc. or creation date may also be evaluated against user roles.

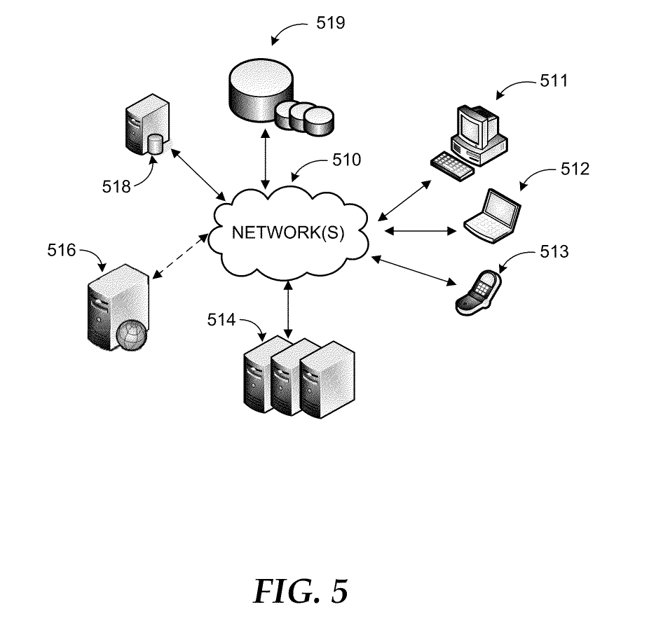

FIG. 5 is an example networked environment, where embodiments may be implemented. A platform providing user role based customizable searches may be implemented via software executed over one or more servers 514 such as a hosted service. The platform may communicate with client applications on individual computing devices such as a smart phone 513, a laptop computer 512, or desktop computer 511 ('client devices') through network(s) 510.

As discussed above, client applications executed on any of the client devices 511-513 may submit a search request to a search engine on the client device 511-513, on the servers 514, or on individual server 516. The search engine may determine any relevant user roles such as enterprise attributes, social networking attributes, permission levels, and comparable ones for the user submitting the request. The search engine may then perform the search ranking documents considering the user roles as discussed previously. The service may retrieve relevant data from data store(s) 519 directly or through database server 518, and provide the ranked search results to the user(s) through client devices 511-513.

Network(s) 510 may comprise any topology of servers, clients, Internet service providers, and communication media. A system according to embodiments may have a static or dynamic topology. Network(s) 510 may include secure networks such as an enterprise network, an unsecure network such as a wireless open network, or the Internet. Network(s) 510 may also coordinate communication over other networks such as Public Switched Telephone Network (PSTN) or cellular networks. Furthermore, network(s) 510 may include short range wireless networks such as Bluetooth or similar ones. Network(s) 510 provide communication between the nodes described herein. By way of example, and not limitation, network(s) 510 may include wireless media such as acoustic, RF, infrared and other wireless media.

Many other configurations of computing devices, applications, data sources, and data distribution systems may be employed to implement a framework for user role based customizable search. Furthermore, the networked environments discussed in FIG. 5 are for illustration purposes only. Embodiments are not limited to the example applications, modules, or processes.

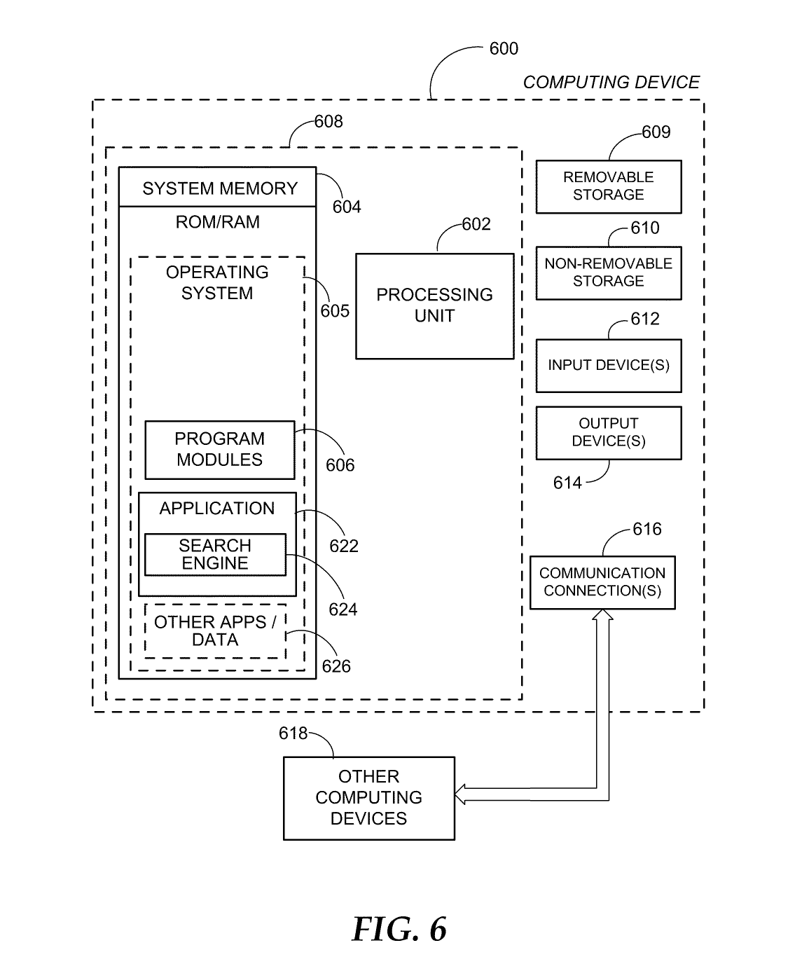

FIG. 6 and the associated discussion are intended to provide a brief, general description of a suitable computing environment in which embodiments may be implemented. With reference to FIG. 6, a block diagram of an example computing operating environment for an application according to embodiments is illustrated, such as computing device 600. In a basic configuration, computing device 600 may be a client device executing a client application capable of performing searches or a server executing a service capable of performing searches according to embodiments and include at least one processing unit 602 and system memory 604. Computing device 600 may also include a plurality of processing units that cooperate in executing programs. Depending on the exact configuration and type of computing device, the system memory 604 may be volatile (such as RAM), non-volatile (such as ROM, flash memory, etc.) or some combination of the two. System memory 604 typically includes an operating system 605 suitable for controlling the operation of the platform, such as the WINDOWS® operating systems from MICROSOFT CORPORATION of Redmond, Wash. The system memory 604 may also include one or more software applications such as program modules 606, search capable application 622, search engine 624, and optionally other applications/data 626.

Application 622 may be any application that is capable of performing search through search engine 624 on other applications/data 626 in computing device 600 and/or on various kinds of data available in an enterprise-based or cloud-based networked environment. Search engine 624 may determine user role(s) and attribute(s), and customize searches and rank results taking those roles and attributes into account as discussed previously. Application 622 and search engine 624 may be separate applications or an integral component of a hosted service. This basic configuration is illustrated in FIG. 6 by those components within dashed line 608.

Computing device 600 may have additional features or functionality. For example, the computing device 600 may also include additional data storage devices (removable and/or non-removable) such as, for example, magnetic disks, optical disks, or tape. Such additional storage is illustrated in FIG. 6 by removable storage 609 and non-removable storage 610. Computer readable storage media may include volatile and nonvolatile, removable and non-removable media implemented in any method or technology for storage of information, such as computer readable instructions, data structures, program modules, or other data. System memory 604, removable storage 609 and non-removable storage 610 are all examples of computer readable storage media. Computer readable storage media includes, but is not limited to, RAM, ROM, EEPROM, flash memory or other memory technology, CD-ROM, digital versatile disks (DVD) or other optical storage, magnetic tape, magnetic disk storage or other magnetic storage devices, or any other medium which can be used to store the desired information and which can be accessed by computing device 600. Any such computer readable storage media may be part of computing device 600. Computing device 600 may also have input device(s) 612 such as keyboard, mouse, pen, voice input device, touch input device, and comparable input devices. Output device(s) 614 such as a display, speakers, printer, and other types of output devices may also be included. These devices are well known in the art and need not be discussed at length here.

Computing device 600 may also contain communication connections 616 that allow the device to communicate with other devices 618, such as over a wired or wireless network in a distributed computing environment, a satellite link, a cellular link, a short range network, and comparable mechanisms. Other devices 618 may include computer device(s) that execute communication applications, other web servers, and comparable devices. Communication connection(s) 616 is one example of communication media. Communication media can include therein computer readable instructions, data structures, program modules, or other data. By way of example, and not limitation, communication media includes wired media such as a wired network or direct-wired connection, and wireless media such as acoustic, RF, infrared and other wireless media.

Example embodiments also include methods. These methods can be implemented in any number of ways, including the structures described in this document. One such way is by machine operations, of devices of the type described in this document.

Another optional way is for one or more of the individual operations of the methods to be performed in conjunction with one or more human operators performing some. These human operators need not be collocated with each other, but each can be only with a machine that performs a portion of the program.

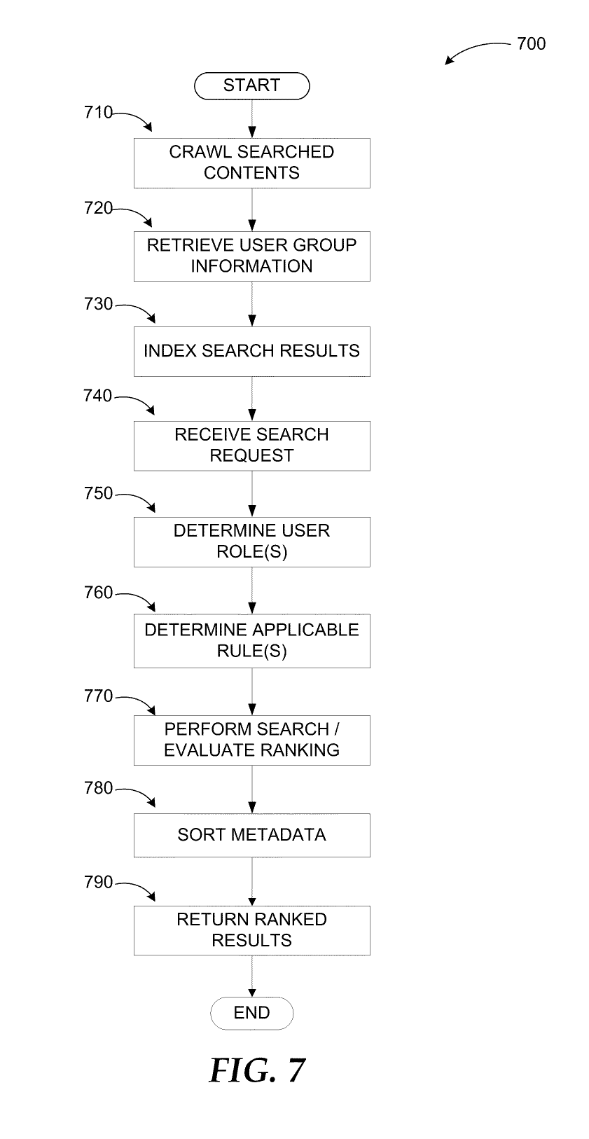

FIG. 7 illustrates a logic flow diagram for a process 700 of performing user role based customizable search according to embodiments. Process 700 may be implemented as part of an application executed on a server or client device.

Process 700 begins with operation 710, where searched contents are crawled. During crawl time special handling is performed, for example, using security credential or adding metadata for each user. At operation 720, user group information is retrieved (e.g. based on user credentials). This may be followed by operation 730, where search results are indexed (for fast retrieval of information). At operation 740, a search request is received from a user. At subsequent operation 750 one or more user roles may be determined based on the retrieved user group specific information. The user roles may include any attribute, permission, credential associated with the user submitting the search request. The roles may be determined through lookup (e.g. looking up a table of user credentials and corresponding roles, etc.), inference (e.g. an automatic inference algorithm inferring a user role based on the user's email address, etc.), predefined rules defining user roles, or similar methods. According to some embodiments, the user roles may already be determined prior to receiving the search request.

At operation 760, applicable rules may be determined The rules may be predefined by a user or administrator, automatically defined/adjusted based on system parameters and/or user role(s) determined at operation 750. The applicable rules are defined to evaluate the importance of contents of a document and metadata associated with the document for specific user role(s). At operation 770, the search may be performed employing the rules and evaluating ranking of documents at query time. Searched document contents may include textual data, graphical data, video data, embedded content, characters, and comparable content. According to other embodiments, user role(s) may be passed as a query parameter. At operation 780, different groups of metadata associated with discovered documents may be sorted based on their importance with regard to the user role(s) and included in the ranked results, which are returned to the requesting application at operation 790.

The operations included in process 700 are for illustration purposes. User role based customizable search may be implemented by similar processes with fewer or additional steps, as well as in different order of operations using the principles described herein.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A method to be executed at least in part in a computing device for performing user role based customizable searches, the method comprising:
crawling searched contents;
retrieving user group specific information;
indexing search results based on the user group specific information;
receiving a search request from a user;
determining a user role for the user;
determining at least one applicable rule for evaluating document content relevance based on the user role;
ranking the search results taking into consideration the user role; and
rendering the search results.

2. The method of claim 1, further comprising:
determining at least one other applicable rule for evaluating document metadata relevance based on the user role; and
evaluating the documents based on the at least one other rule.

3. The method of claim 1, further comprising:
determining at least one further applicable rule for rendering documents based on metadata relevance to the user role; and
rendering the search results based on the at least one further rule.

4. The method of claim 3, wherein the at least one further rule defines groups of metadata based on relevance to the user role.

5. The method of claim 1, wherein the user role is determined based on at least one from a set of: an organizational hierarchy, a profession, an age, a social status, a membership in an organization, and a gender of the user.

6. The method of claim 1, wherein the user role is determined from a user credential based on a look-up operation, an inference, and by executing a derivation algorithm.

7. The method of claim 6, wherein the user credential includes one of: a login, a username/password combination, a certificate, a personal identification number, and an email address.

8. The method of claim 1, wherein the search is performed in one of a desktop environment and a networked environment.

9. The method of claim 1, wherein the user role is determined in response to one of: expiration of a predefined period, expiration of a random period, and a user indication.

10. The method of claim 1, wherein the document content includes at least one from a set of: textual data, graphical data, video data, embedded content, and characters.

11. A server for facilitating user role based customizable searches in a networked system, the server comprising:
a memory;
a processor coupled to the memory, the processor executing a search application in conjunction with instructions stored in the memory, wherein the search application is configured to:
receive a user credential and a search request associated with a user;
crawl searched contents;
retrieve user group specific information based on the user credential;
index search results based on the user group specific information;
determine at least one user role for the user based on the user group specific information;
determine applicable rules for evaluating document content relevance and evaluating document metadata relevance based on the user role;
evaluate documents based on the applicable rules;
rank the search results;
determine an applicable rule for rendering documents based on metadata relevance to the user role; and
provide the ranked search results ranked according to the rule for rendering the documents to a client application.

12. The server of claim 11, wherein documents deemed to be relevant to the user based on at least one of document content and document metadata are ranked higher in the rendered search results.

13. The server of claim 12, wherein the rendered search results include ranked documents and relevant document metadata.

14. The server of claim 11, wherein the user role is determined in one of a random, periodic, and on-demand manner, and the determined user role is stored for subsequent use.

15. The server of claim 11, wherein the user role is determined based on at least one from a set of: a system rule, a user association, and user personal information.

16. The server of claim 11, wherein the search is performed on at least one from a set of: a database source, an analysis service, a portal, another server, and a desktop.

17. The server of claim 11, wherein the system comprises one of: an enterprise-based network, a cloud-based network, and a combination of an enterprise-based network and a cloud-based network.

18. A computer-readable storage medium with instructions stored thereon for performing user role based customizable searches, the instructions comprising:
crawling searched contents;
retrieving user group specific information;
indexing search results based on the user group specific information;
receiving a search request from a user;
determining a plurality of user roles based on at least one from a set of: a system rule, a user association, user group specific information, and user personal information;
evaluating documents based on their content and the user roles;
grouping metadata associated with documents and evaluating each metadata group based on the user roles;
ranking documents based on the evaluations; and
rendering search results comprising the ranked documents and the associated metadata.

19. The computer-readable medium of claim 18, wherein the instructions further comprise:
customizing each group of metadata based on the user roles for rendering the search results.

20. The computer-readable medium of claim 18, wherein performing the search includes executing a query and passing customizable rules based on user roles for evaluating the documents and the metadata groups as query parameters.
